(19) United States
(12) Patent Application Publication
(10) Pub. No.: US 2013/0129254 A1
(43) Pub. Date: May 23, 2013

(54) APPARATUS FOR PROJECTING SECONDARY INFORMATION INTO AN OPTICAL SYSTEM

(71) Applicant: THERMOTEKNIX SYSTEMS LIMITED, Cambridge (GB)

(72) Inventor: Richard Salisbury, Cambridge (GB)

(73) Assignee: THERMOTEKNIX SYSTEMS LIMITED, Cambridge (GB)

(21) Appl. No.: 13/680,600

(22) Filed: Nov. 19, 2012

(30) Foreign Application Priority Data
Nov. 17, 2011 (GB) 1119874.4

(51) Int. Cl. G06T 11/60

(52) U.S. Cl. CPC G06T 11/60
USPC 382/284

(57) ABSTRACT

An apparatus is operable to project secondary information into an optical system so as to form a secondary image that can overlay a primary image of a night scene. The apparatus includes a generating means operable to generate secondary information, a projecting means operable to project the secondary information into an optical system (not shown) so as to form a secondary image, and a monitoring means operable to monitor the position and/or orientation of the optical system. The apparatus further includes a receiving means for receiving one or more first external signals indicating the location(s) of: other nearby friendly persons, rendezvous points etc. The secondary information may then include a graphic identifying each friendly person in the field of view.

### BACKGROUND AND SUMMARY OF THE INVENTION

The present invention relates to an apparatus for projecting a secondary image into an optical system to overlay a primary image so as to form a composite image. In particular, it relates to an apparatus for projecting secondary information on to an image captured at night or in low light conditions.

Many types of optical system are used to form images and it is often desirable to display additional, secondary information overlaid on the main image. An example is provided in the field of night vision technology.

There are two common techniques for imaging a night scene. The first involves an image intensifier to amplify a signal provided by low levels of ambient light so that it can be resolved by a human eye. The second utilizes infra-red detection to form a thermal image, which can be used to distinguish between different objects in the night scene based on their temperature. It is known in this field (see, for example, US2008/0302966) to use an image intensifier that can form a primary image of the night scene, use an infra-red camera to form a secondary image of the night scene and project the secondary image into the optical system of the image intensifier so that a composite image may be formed. This arrangement can be incorporated into a headset or helmet to be worn by the user.

Furthermore, alternatively, it is known to project other secondary information into the optical system of an image intensifier to form part of a composite image. This secondary information may comprise text, menu or any other information as desired or required.

However, the additional secondary information provided by such prior art arrangements remains static regardless of the current position of the user and is not updated dynamically as the user moves. Therefore, the user may need to consult additional sources of information in order to interpret the secondary information. For example, if the secondary information comprises directions to a specific location, the user may need to consult a map and/or a compass as he progresses towards the location. This is at best inconvenient. If this consultation must be done at night or in a low light environment it may require a light source such as a torch to be switched on temporarily. This is particularly undesirable in this field since the light source may betray the location of the user to an enemy and/or may temporarily impair the ability of the user to view the scene through the image intensifier.

It is an object of embodiments of the present invention to at least partially overcome or alleviate the above problems.

According to a first aspect of the present invention there is provided an apparatus for projecting secondary information in to an optical system so as to form a secondary image that can overlay a primary image, said apparatus comprising: a generating means operable to generate secondary information; a projecting means operable to project the secondary information into an optical system so as to form a secondary image; and a monitoring means operable to monitor the position and/or orientation of the optical system characterized in that the secondary information is dependent upon the monitored position and/or orientation of the optical system.

Such an arrangement allows for the secondary information to be dynamically updated in real time as the apparatus and its user move. Advantageously, this arrangement eliminates any need for a user to consult additional sources of information. In night or low light conditions this reduces the risk of betraying the location of the user to an enemy and/or impairing the ability of the user to view the primary image.

Preferably, the primary image is an image of a night or low light scene. The primary image is preferably captured by an imaging component of the optical system. The imaging component may be an image intensifier or an infra-red camera.

The apparatus may comprise a low light or night imaging device. Preferably, the apparatus may comprise a user mounted low light or night imaging device. In particular, the user mounted low light or night imaging device may be head mounted. The low light or night imaging device may be monocular or binocular as required or desired. In such circumstances, the user can be provided with new or updated information in a ‘hands free’ manner. Additionally, the user need not consult other equipment and or activate any additional light sources.

The projecting means may comprise any optical components necessary to project the secondary information into the optical system so as to form a secondary image. In particular, the projection means may comprise a light guiding device as disclosed in GB2472516 or GB2468948.

The generating means may comprise a processor which is operable to receive a signal from the monitoring means indicative of the monitored position and/or orientation of the optical system and to alter the secondary information accordingly.

The monitoring means comprises location sensors operable to monitor the position and/or orientation of the optical system. The location sensors preferably include some or all of the following: gyroscopes, accelerometers, global positioning system (GPS) receivers and a compass. The gyroscopes may comprise MEMS three axis gyroscopes. The compass may comprise a digital compass. The location sensors may further comprise any or all of the following: magnetic field sensors, orientation sensors, gravity sensors, linear acceleration sensors and rotation vector sensors. The magnetic field sensors may comprise a three axis magnetic field sensor.

The apparatus may further comprise a receiving means for receiving one or more first external signals. Said first external signals may be used by the generating means to generate the secondary information. Advantageously, this allows the secondary information to be updated dynamically and in real time as a result of any external changes without the need for the user to consult any additional sources of information which may have required a light source to be switched on temporarily. For example, a new order may be given whilst users are out in the field. Rather than these orders being received by an alternative means that the user must consult and then use to alter the secondary information manually, the apparatus can receive these via the receiving means and automatically update the secondary information.

The one or more first external signals may comprise the coordinates of one or more specific locations or the current locations of mobile objects. In particular, said specific locations or mobile objects may include any of the following: friendly persons or forces; rendezvous points; target locations; sniper positions and/or Intelligence, Surveillance, Target Acquisition and Reconnaissance (ISTAR) data. These may be determined using laser targeters, gunfire locators or Unmanned Aerial Vehicle (UAV) drones such as Predator or Reaper.

For embodiments wherein the one or more first external signals indicate the location of other specific locations or mobile objects in the vicinity of the user, the secondary information may comprise a graphic identifying each specific locations or mobile objects in the field of view of the user. Advantageously, where these are friendly persons, this can help eliminate, or at least reduce, the risk of “blue on blue” or “friendly fire”. The generating means is preferably operable to update said graphics dynamically according to relative position and viewing direction. It would be possible to uniquely identify each battlefield participant, specific location or mobile object and indicate their distance and/or speed. If a specific location or mobile object is not in the field of view of the user then the generating means may generate a graphic which indicates to the user which way he must face in order for that specific location or mobile object to be in the field of view of the user. For example, if the user needs to turn to the left, an arrow may be provided pointing to the left.

The secondary information may comprise an indicator. The indicator may serve to help guide a user to a specific location or mobile object. The indicator may indicate the distance, bearing and elevation of the specific location or mobile object. The indicator may comprise an identification code for the or each specific location or mobile object. The indicator may comprise an arrow overlaid on the primary image. Preferably, the arrow points in the direction of the specific location or mobile object. The indicator may further comprise text indicating the distance to the specific location or mobile object. Additionally or alternatively, the size of the arrow may be dependent upon the distance to the specific location or mobile object. For example, the size of the arrow may increase as the user draws closer to the specific location or mobile object. The generating means is preferably operable to dynamically redraw the indicator in response to the monitored position and/or orientation of the optical system. Therefore, the arrow always points to the correct position irrespective of the viewing direction of the user. If the specific location or mobile object is not in the field of view of the user then the generating means may generate a graphic which indicates to the user which way he must face in order for the specific location or mobile object to be in the field of view of the user. For example, if the user needs to turn to the left, an arrow may be provided pointing to the left.

For embodiments wherein the first external signals comprise the location of a one of more mobile objects, the first external signals may further comprise the speed of that object.

For embodiments wherein the first external signals comprise the location of a one or more mobile objects, the first external signals may further comprise an identification code for that object. This can allow the user to distinguish between two different friendly persons.

The specific location may be a final destination or an intermediate destination.

The first external signal may be transmitted directly from its source to the user or via an intermediary.

The apparatus may be operable to receive a plurality of first external signals. Said plurality of external signals may originate from the same source or from a plurality of distinct sources.

Preferably, the first external signal is encrypted and the apparatus is provided with a means for decoding it. This functionality may be provided by the receiving means, the generating means or a separate, dedicated module. Advantageously, this reduces the risk that the information contained in the first external signal can be extracted by unfriendly persons who may intercept the first external signal.

Preferably, the apparatus further comprises an authentication means. The authentication means may be operable to analyse the first external signal and determine whether or not it has originated from a friendly source. This functionality may be provided by the receiving means, the generating means or a separate, dedicated module. Advantageously, this allows misinformation provided by unfriendly sources to be disregarded.

The apparatus may further comprise a transmitting means for transmitting a second external signal. Said second external signal may comprise information relating to the position of the apparatus/optical system. This can allow the user of one apparatus according to the present invention to communicate his position to another person who is a user of another apparatus according to the present invention or other suitable equipment.

Preferably, the apparatus further comprises a means for encrypting the second external signal. Advantageously, this reduces the risk that the information contained in the second external signal can be extracted by unfriendly persons who may intercept the second external signal.

Preferably, the apparatus is operable to generate the second external signal in such a fashion so that recipients of the second external system are able to determine whether or not the second external signal originated from the user. Advantageously, this allows friendly recipients to disregard potential misinformation provided by unfriendly sources.

The second external signal may be transmitted directly from the user to other friendly persons or via an intermediary.

The apparatus may be operable to transmit the second external signal substantially continuously. Alternatively, the apparatus may be operable to transmit the second external signal intermittently.

The receiving means and transmitting means may be provided separately or as a combined transceiver.

The receiving means and transmitting means may allow the apparatus to connect to other persons via a wireless network. The wireless network may be a wireless ad-hoc network.

According to a second aspect of the present invention there is provided a method of navigating to a specific location using an apparatus according to the first aspect of the present invention, said method comprising the steps of: receiving a signal containing the coordinates of the specific location; monitoring the position of the user; calculating any one or more of the distance, bearing and elevation of the specific location relative to the user and generating an indicator thereof; and projecting said indicator into the optical system so as to form a secondary image that can overlay a primary image.

The method of the second aspect of the present invention may comprise any or all of the features of the apparatus of the first aspect of the present invention as desired or required.

Preferably, the primary image is an image of a night or low light scene. The primary image is preferably captured by an imaging component of the optical system.

In particular, the indicator may comprise an arrow overlaid on the primary image. Preferably, the arrow points in the direction of the specific location. The indicator may further comprise text indicating the distance to the specific location. Additionally or alternatively, the size of the arrow may be dependent upon the distance to the specific location. For example, the size of the arrow may increase as the user draws closer to the specific location. The generating means is preferably operable to dynamically redraw the indicator in response to the monitored position and/or orientation of the optical system. Therefore, the arrow always points to the correct position irrespective of the viewing direction of the user. If the specific location is not in the field of view of the user then the generating means may generate a graphic which indicates to the user which way he must face in order for the specific location to be in the field of view of the user. For example, if the user needs to turn to the left, an arrow may be provided pointing to the left.

According to a third aspect of the present invention there is provided a method of monitoring the presence and location of one or more mobile objects using an apparatus according to the first aspect of the present invention, said method comprising the steps of: receiving one or more signals containing the coordinates of one or more mobile objects; monitoring the position of the user; calculating any one or more of the distance, bearing and elevation of each of the one or more mobile objects relative to the user and generating an indicator thereof; and projecting said indicator into the optical system so as to form a secondary image that can overlay a primary image.

Typically, one or more mobile objects might be friendly forces. Advantageously, this can help eliminate, or at least reduce, the risk of “blue on blue” or “friendly fire”.

The method of the third aspect of the present invention may comprise any or all of the features of the apparatus of the first aspect of the present invention and/or the method of the second aspect of the present invention as desired or required.

Preferably, the primary image is an image of a night or low light scene. The primary image is preferably captured by an imaging component of the optical system.

The one or more signals may additionally comprise the speed of each mobile object. The indicator may also indicate the speed of each mobile object.

The one or more signals may further comprise an identification code for each mobile object. The indicator may also indicate the identification code of each mobile object. This can allow the user to distinguish between two different friendly persons.

It would therefore be possible to uniquely identify each battlefield participant and indicate their direction, distance and speed.

The indicator may indicate the distance, bearing and elevation of each mobile object. The indicator may comprise any suitable graphic overlaid on the primary image. Preferably, the indicator further comprises text indicating the distance to the specific location. The generating means is preferably operable to dynamically redraw the indicator in response to the monitored position and/or orientation of the optical system. Therefore, the graphic for each mobile object always appears in the appropriate part of the field of view of the user irrespective of his viewing direction. If one of the mobile objects are not in the field of view of the user then the generating means may generate a graphic which indicates to the user which way he must face in order for that mobile object to be in the field of view of the user. For example, if the user needs to turn to the left then an arrow or similar pointing to the left may be provided.

The method may include transmitting a corresponding signal containing the coordinates of the user. Preferably, each mobile object is provided with means for transmitting such signals. The means may comprise an apparatus according to the first aspect of the invention.

### BRIEF DESCRIPTION OF THE DRAWING FIGURE

In order that the present invention is more clearly understood, one embodiment will now be described, by way of example only and with reference to the single accompanying drawing wherein:

FIG. 1 is a block diagram showing the components of an apparatus according to the present invention.

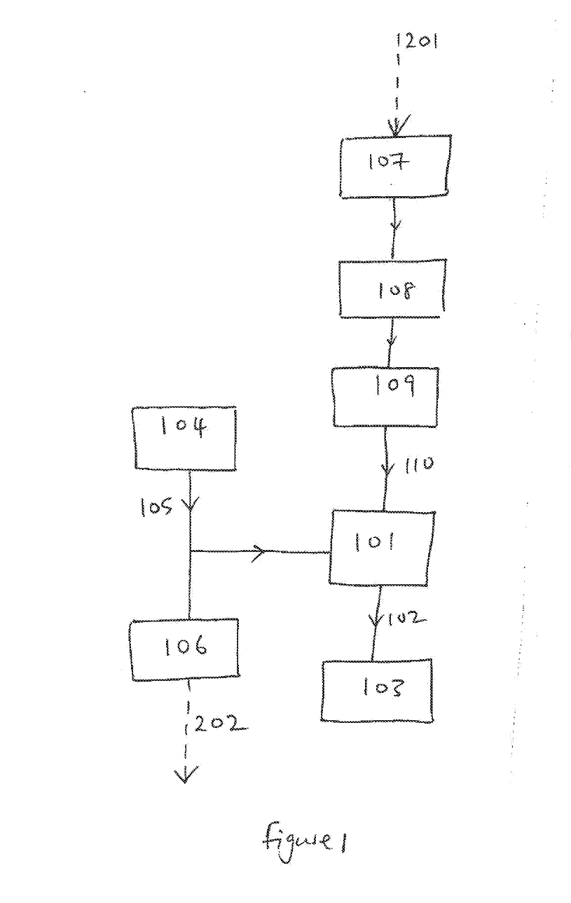

### DESCRIPTION OF THE PREFERRED EMBODIMENT

Referring to the single FIGURE an apparatus 100 for projecting secondary information in to an optical system so as to form a secondary image that can overlay a primary image of a night scene according to the present invention is shown. The apparatus 100 comprises: a generating means 101 operable to generate secondary information 102; a projecting means 103 operable to project the secondary information 102 into an optical system (not shown) so as to form a secondary image; and a monitoring means 104 operable to monitor the position and/or orientation of the optical system.

In use, the monitoring means 104 is operable to monitor the position and/or orientation of the optical system and output a signal 105 indicative thereof. The generating means 101 comprises a processor which is operable to receive said signal 105 from the monitoring means 104 and to alter the secondary information 102 generated accordingly.

The projecting means 103 may comprise any optical components necessary to project the secondary information 102 into the optical system so as to form a secondary image. In particular, the projection means may comprise a light guiding device as disclosed in GB2472516 or GB2468948.

The monitoring means 104 comprises location sensors operable to monitor the position and/or orientation of the optical system. The location sensors include: gyroscopes, accelerometers, global positioning system (GPS) receivers and a compass. The gyroscopes preferably comprise MEMS three axis gyroscopes. The compass is preferably a digital compass. The location sensors may further comprise any or all of the following: three axis magnetic field sensors, orientation sensors, gravity sensors, linear acceleration sensors and rotation vector sensors.

The apparatus further comprises a receiving means 107 for receiving one or more first external signals 201. Said first external signals 201 are decoded by a decoding means 108 and authenticated by an authentication means 109. If authenticated as originating from a friendly source, the decoded signal 110 is transmitted to the generating means 101 and used to generate the secondary information 102. Advantageously, this allows the secondary information to be updated dynamically and in real time as a result of any external changes without the need for the user to consult any additional sources of information which may have required a light source to be switched on temporarily.

The first external signals 201 may indicate the location(s) of: other friendly persons in the vicinity of the user; rendezvous points; target locations; sniper positions and/or Intelligence, Surveillance, Target Acquisition and Reconnaissance (ISTAR) data.

For embodiments wherein the one or more first external signals 201 indicate the location of other friendly persons, the secondary information 102 comprises a graphic identifying each friendly person in the field of view of the user. Advantageously, this can help eliminate, or at least reduce, the risk of “blue on blue” or “friendly fire”. The generating means 101 is operable to update said graphics dynamically according to relative position and viewing direction. It is therefore possible to uniquely identify each battlefield participant and indicate their distance and/or speed. If a friendly person is not in the field of view of the user then the generating means may generate a graphic which indicates to the user which way he must face in order for that friendly person to be in the field of view of the user. For example, if the user needs to turn to the left, an arrow may be provided pointing to the left.

Each first external signal 201 may be transmitted directly from its source to the apparatus 100 or via an intermediary.

The secondary information 102 may comprise an indicator which serves to help guide a user to a specific location. The indicator may indicate the distance, bearing and elevation of the specific location. Preferably, the indicator comprises an arrow overlaid on the primary image and pointing in the direction of the specific location. The indicator may further comprise text indicating the distance to the specific location. Additionally or alternatively, the size of the arrow may be dependent upon the distance to the specific location. For example, the size of the arrow may increase as the user draws closer to the specific location. The generating means 101 is operable to dynamically redraw the indicator in response to the monitored position and/or orientation 105 of the optical system. Therefore, the arrow always points to the correct position irrespective of the viewing direction of the user. If the specific location is not in the field of view of the user then the generating means may generate a graphic which indicates to the user which way he must face in order for the specific location to be in the field of view of the user. For example, if the user needs to turn to the left, an arrow may be provided pointing to the left.

For example, the commander of a section may wish to communicate the coordinates of a waypoint for rendezvous to the members of the section, each of which has been provided with an apparatus 100 according to the present invention. He can do so by sending a first external signal 201. This may be achieved by sending a message 201 comprising the text “RP” (Rendezvous Point) and the GPS coordinates of the waypoint to each member of the section. The generating means 101 of each apparatus 100 will know the coordinates of its user (by virtue of the signal 105) and will calculate the distance, bearing and elevation from its user to the RP. An arrow will appear in the intensifier overlay with accompanying text, for example “RP 500m”.

The apparatus further comprises a transmitting means 106 for transmitting a second external signal 202. The transmitting means 106 is operable to receive the signal 105 output by the monitoring means 104 indicative of the monitored position and orientation of the optical system. The transmitting means 106 is further operable to generate a second external signal 202 which is indicative of the position of the optical system and which allows recipients of the second external signal 202 to determine whether or not it originated from the user. This allows the user of the apparatus 100 to communicate his position to another friendly person.

The second external signal 202 may be transmitted directly from the user to other friendly persons or via an intermediary.

The receiving means 107 and transmitting means 106 may allow the apparatus to connect to other persons via a wireless network (not shown). The wireless network may be a wireless ad-hoc network.

It is of course to be understood that the present invention is not to be limited to the details of the above embodiment which is described by way of example only.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. An apparatus for projecting secondary information in to an optical system so as to form a secondary image that can overlay a primary image, said apparatus comprising:
a generating means operable to generate secondary information;
a monitoring means operable to monitor the position and/or orientation of the optical system;
a projecting means operable to project the secondary information into an optical system so as to form a secondary image wherein the secondary information is dependent upon the monitored position and/or orientation of the optical system; and
a receiving means operable to receive one or more first external signals comprising the coordinates of one or more specific locations or the coordinates of the current locations of one or more mobile objects characterized in that said one or more first external signals are used by the generating means in the generation of the secondary information.

2. An apparatus as claimed in claim 1 wherein the primary image is an image of a night or low light scene.

3. An apparatus as claimed in claim 1 wherein the apparatus comprises a head mounted low light or night imaging device.

4. An apparatus as claimed in claim 1 wherein the first external signals further comprise the speed of said mobile objects.

5. An apparatus as claimed in claim 1 wherein the first external signals further comprise an identification code for each specific location or mobile object.

6. An apparatus as claimed in claim 1 wherein the secondary information comprises a graphic identifying each specific location or mobile object in the field of view of the user and the generating means is operable to update said graphics dynamically according to the monitored relative position and orientation.

7. An apparatus as claimed in claim 1 wherein in the event that one or more of the first external signals indicates a specific location or mobile object that is not in the field of view of the user then the generating means generates a graphic which indicates to the user which way he must face in order for that specific location or mobile object to be in the field of view of the user.

8. An apparatus as claimed in claim 1 wherein the secondary information comprises an indicator which indicates any one or more of the distance, bearing or elevation of one or more of the specific locations or mobile objects.

9. An apparatus as claimed in claim 8 wherein the indicator comprises an identification code for the or each specific location or mobile object.

10. An apparatus as claimed in claim 8 wherein the indicator comprises an arrow which points in the direction of one of the specific locations or mobile objects and which is overlaid on the primary image.

11. An apparatus as claimed in claim 10 wherein the indicator further comprises text indicating the distance to that specific location or mobile object.

12. An apparatus as claimed in claim 10 wherein the size of the arrow is dependent upon the distance to the specific location or mobile object so that the size of the arrow increases as the user draws closer to the specific location or mobile object.

13. An apparatus as claimed in claim 8 wherein the generating means is operable to dynamically redraw the indicator in response to the monitored position and/or orientation of the optical system.

14. An apparatus as claimed in claim 8 wherein if one or more of the specific locations or mobile objects are not in the field of view of the user then the indicator indicates to the user which way he must face in order for that specific location or mobile objects to be in the field of view of the user.

15. An apparatus as claimed in claim 8 wherein the indicator further comprises an indication of the speed of that mobile object.

16. An apparatus as claimed in claim 1 further comprising a transmitting means for transmitting a second external signal, said second external signal comprising information relating to the monitored position of the optical system.

17. An apparatus as claimed in claim 16 wherein the apparatus is operable to transmit the second external signal substantially continuously or intermittently.

18. A method of navigating to a specific location comprising the steps of:
providing an apparatus comprising: a generating means operable to generate secondary information; a monitoring means operable to monitor the position and/or orientation of the optical system; a projecting means operable to project the secondary information into an optical system so as to form a secondary image wherein the secondary information is dependent upon the monitored position and/or orientation of the optical system; and a receiving means operable to receive one or more first external signals comprising the coordinates of one or more specific locations or the coordinates of the current locations of one or more mobile objects characterized in that said one or more first external signals are used by the generating means in the generation of the secondary information;
receiving a signal containing the coordinates of the specific location;
monitoring the position of the user;
calculating any one of the distance, bearing or elevation of the specific location relative to the user and generating an indicator thereof; and
projecting said indicator into the optical system so as to form a secondary image that can overlay a primary image.

19. A method as claimed in claim 18 wherein the indicator comprises an arrow overlaid on the primary image and wherein the arrow points in the direction of the specific location.

20. A method as claimed in claim 18 wherein the indicator comprises text indicating the distance to the specific location.

21. A method as claimed in claim 19 wherein the size of the arrow is dependent upon the distance to the specific location.

22. A method as claimed in claim 18 wherein the generating means is operable to dynamically redraw the indicator in response to the monitored position and/or orientation of the optical system.

23. A method as claimed in claim 18 wherein if the specific location is not in the field of view of the user then the generating means will generate a graphic which indicates to the user which way he must face in order for the specific location to be in the field of view of the user.

24. A method of monitoring the presence and location of one or more mobile objects comprising the steps of:
providing an apparatus comprising: a generating means operable to generate secondary information; a monitoring means operable to monitor the position and/or orientation of the optical system; a projecting means operable to project the secondary information into an optical system so as to form a secondary image wherein the secondary information is dependent upon the monitored position and/or orientation of the optical system; and a receiving means operable to receive one or more first external signals comprising the coordinates of one or more specific locations or the coordinates of the current locations of one or more mobile objects characterized in that said one or more first external signals are used by the generating means in the generation of the secondary information;
receiving one or more signals containing the coordinates of one or more mobile objects;
monitoring the position of the user; calculating any one or more of the distance, bearing and elevation of each of the one or more mobile objects relative to the user and generating an indicator thereof; and
projecting said indicator into the optical system so as to form a secondary image that can overlay a primary image.

25. A method as claimed in claim 24 wherein one or more of the signals additionally comprises the speed of each mobile object and the indicator indicates the speed of each mobile object.

26. A method as claimed in claim 24 wherein one or more of the signals further comprises an identification code for each mobile object and the indicator indicates the identification code of each mobile object.

27. A method as claimed in claim 24 wherein the indicator comprises text indicating the distance to each mobile object.

28. A method as claimed in claim 24 wherein the indicator is dynamically regenerated in response to the monitored position and/or orientation of the optical system.

29. A method as claimed in claim 24 wherein if one of the mobile objects are not in the field of view of the user then a graphic is generated which indicates to the user which way he must face in order for that mobile object to be in the field of view of the user.

30. A method as claimed in claim 24 wherein a corresponding signal containing the coordinates of the user is transmitted.
